(19) United States
(12) Patent Application Publication
(10) Pub. No.: US 2014/0306608 A1
(43) Pub. Date: Oct. 16, 2014

(54) ION GENERATING ELEMENT AND ION GENERATING APPARATUS PROVIDED THEREWITH

(71) Applicant: SHARP KABUSHIKI KAISHA, Osaka-shi, Osaka (JP)

(72) Inventors: Seiichi Nagatome, Osaka-shi (JP); Kouji Horikawa, Osaka-shi (JP); Kazuharu Date, Osaka-shi (JP); Keiji Ishida, Osaka-shi (JP)

(21) Appl. No.: 14/355,276

(22) PCT Filed: Sep. 27, 2012
(86) PCT No.: PCT/JP2012/074823

§ 371 Date: Apr. 30, 2014

(30) Foreign Application Priority Data
Nov. 1, 2011 (JP) 2011-240210

(51) Int. Cl. H01J 27/02

(52) U.S. Cl. CPC H01J 27/022
USPC 315/111.81

(57) ABSTRACT

An ion generating element (10) is provided with: a needle-shaped ion discharge unit (11) that generates ions in the air by means of discharge; a voltage generating unit (13) that generates voltage to be applied to the ion discharge unit (11); and a rectifier element (14) that is connected between the ion discharge unit (11) and the voltage generating unit (13), and applies either the positive or negative portion of the voltage generated by the voltage generating unit (13) to the ion discharge unit (11). The rectifier element (14) is longitudinal in shape, and is disposed at the opposite side of the tip side of the ion discharge unit (11) such that the longitudinal direction of the rectifier element (14) intersects with the axial direction of the needle-shaped ion discharge unit (11).

### TECHNICAL FIELD

The present invention relates to an ion generating element for generating ions in the air by electric discharge. The present invention also relates to an ion generating apparatus provided with such an ion generating element.

### BACKGROUND ART

Recent years have seen a wide spread of air conditioners equipped with an ion generating apparatus, for discharging ions into the air by electric discharge, combined with a blower fan. Such an air conditioner is installed, for example, on a floor surface, and through a discharge port provided in the top face of a unit casing, ions are, along with air, discharged into a room by the ion generating apparatus operating with the blower fan. This permits the ions to be distributed throughout the room.

Inconveniently, however, such an air conditioner requires electric power to rotate the blower fan and generates noise such as the rotation noise of the blower fan. Moreover, an extra space is needed inside the unit casing for arrangement of the blower fan and a motor for driving it, leading to an increased size.

To overcome such inconveniences, there have been proposed ion generating apparatuses that can diffuse ions with no provision of a blowing means such as a blower fan. One conventional example is disclosed in Patent Document 1 identified below. The ion generating apparatus disclosed in Patent Document 1 has a positive electrode which comprises a metal plate in which holes are formed with raised rims around them, and has pointed ends of sharp negative electrodes arranged close to the holes in the positive electrode. With this technique, the raised rims around the holes in the positive electrode produce a stream of air which can satisfactorily diffuse negative ions generated when electric discharge takes place.

### LIST OF CITATIONS

### Patent Literature

Patent Document 1: Japanese Patent Application Publication No. 2005-13831

### SUMMARY OF THE INVENTION

### Problem to be Solved by the Invention

The conventional ion generating apparatus described above has a disadvantage: the positive electrode comprising a metal plate needs to be disposed close to, and further frontward of, the pointed-ends of the sharp negative electrodes. The provision of the positive electrode comprising a metal plate thus results in an increased size of the ion generating apparatus.

Against the background discussed above, an object of the present invention is to provide an ion generating element that is compact, that has a simple structure, and that can diffuse ions satisfactorily with no provision of a blowing means such as a blower fan. Another object of the present invention is to provide an ion generating apparatus provided with such an ion generating element.

### Means for Solving the Problem

To achieve the above objects, according to one aspect of the present invention, an ion generating element is provided with: an ion discharger having a needle-like shape for generating ions in air by electric discharge; a voltage generator for generating a voltage to be applied to the ion discharger; and a rectifier connected between the ion discharger and the voltage generator for applying either a positive or a negative voltage generated by the voltage generator to the ion discharger. Here, the rectifier has an elongate shape. Moreover, the rectifier is arranged at the side of the ion discharger opposite from the pointed-end side thereof such that the longitudinal direction of the rectifier crosses the axial-line direction of the ion discharger.

With this structure, under the influence of the electric field produced around the rectifier, the electric field produced around the ion discharger in directions away from the pointed end thereof tends to be more intense. This makes it easier for ions to be discharged in directions away from the ion discharger without the ion generating element being provided with an extra member at the pointed-end side of the ion discharger.

In the ion generating element structured as described above, preferably, the rectifier is arranged such that the longitudinal direction thereof is substantially perpendicular to the axial-line direction of the ion discharger.

With this structure, under the influence of the electric field produced around the rectifier, the electric field produced around the ion discharger in directions from the base end to the pointed end thereof in the axial-line direction thereof tends to be still more intense. This makes it still easier for ions to be discharged in directions away from the ion discharger.

In the ion generating element structured as described above, preferably, there is further provided a base plate on which the ion discharger is mounted, and the axial line of the ion discharger is perpendicular to the normal line to the base plate. With this structure, the ion generating element has a smaller size in the normal-line direction to the base plate. The ion generating element is thus more compact.

In the ion generating element structured as described above, preferably, there is further provided a base plate on which the ion discharger is mounted, and the axial line of the ion discharger is parallel to the normal line to the base plate. With this structure, the ion generating element is not only more compact but also more flexible in terms of ion discharge direction.

In the ion generating element structured as described above, preferably, the ion discharger includes a positive ion discharger for generating positive ions and a negative ion discharger for generating negative ions, and the rectifier includes a positive-side rectifier connected to the positive ion discharger for applying a positive voltage alone to the positive ion discharger and a negative-side rectifier connected to the negative ion discharger for applying a negative voltage alone to the negative ion discharger.

With this structure, with the positive ion discharger under the influence of the electric field produced around the positive-side rectifier, and with the negative ion discharger under the influence of the electric field produced around the negative-side rectifier, the electric field produced around the ion discharger in directions away from the pointed end thereof tends to be more intense. This makes it easier, with respect to both the positive and negative ion dischargers, for positive and negative ions to be discharged in directions away from them.

In the ion generating element structured as described above, preferably, the axial line of the positive ion discharger and the axial line of the negative ion discharger are substantially parallel to each other, and the axial line of the positive-side rectifier and the axial line of the negative-side rectifier are substantially parallel to each other or are substantially aligned with each other.

With this structure, in a structure where a positive ion discharger and a negative ion discharger are provided, the positive and negative ion dischargers and the positive-side and negative-side rectifiers require a comparatively small arrangement space. The ion generating element is thus more compact.

According to another aspect of the present invention, an ion generating apparatus is provided with an ion generating element as described above. With this structure, it is easier for ions to be discharged in directions away from the ion generating element without the ion generating apparatus being provided with a blowing means such as a blower fan.

### Advantageous Effects of the Invention

According to the present invention, ions are more easily discharged in directions away from an ion discharger with no provision of an extra member at the pointed-end side of the ion discharger. Thus, it is possible to provide an ion generating element that is compact, that has a simple structure, and that can diffuse ions satisfactorily with no provision of a blowing means such as a blower fan. It is also possible to provide an ion generating apparatus provided with such an ion generating element.

### BRIEF DESCRIPTION OF DRAWINGS

FIG. 1 is an exploded perspective view of an ion generating apparatus according to a first embodiment of the present invention;

FIG. 2 is a top view of an ion generating element in the ion generating apparatus shown in FIG. 1;

FIG. 3 is a front view of the ion generating element in the ion generating apparatus shown in FIG. 1;

FIG. 4 is a top view of an ion generating element according to a second embodiment of the present invention;

FIG. 5 is a top view of an ion generating element of a comparative example for comparison with the embodiments of the present invention;

FIG. 6 is a table showing the results of comparison between the embodiments of the present invention and the comparative example in terms of the number of ions;

FIG. 7 is a diagram illustrating directions of ion discharge from an ion discharger alone;

FIG. 8 is a diagram illustrating directions of ion discharge from an ion discharger connected to an electrode;

FIG. 9 is a table showing the results of comparison between the ion dischargers structured as shown in FIGS. 7 and 8 in terms of field intensity;

FIG. 10 is a top view of an ion generating element in an ion generating apparatus according to a third embodiment of the present invention; and

FIG. 11 is a front view of the ion generating element in the ion generating apparatus shown in FIG. 10.

### DESCRIPTION OF EMBODIMENTS

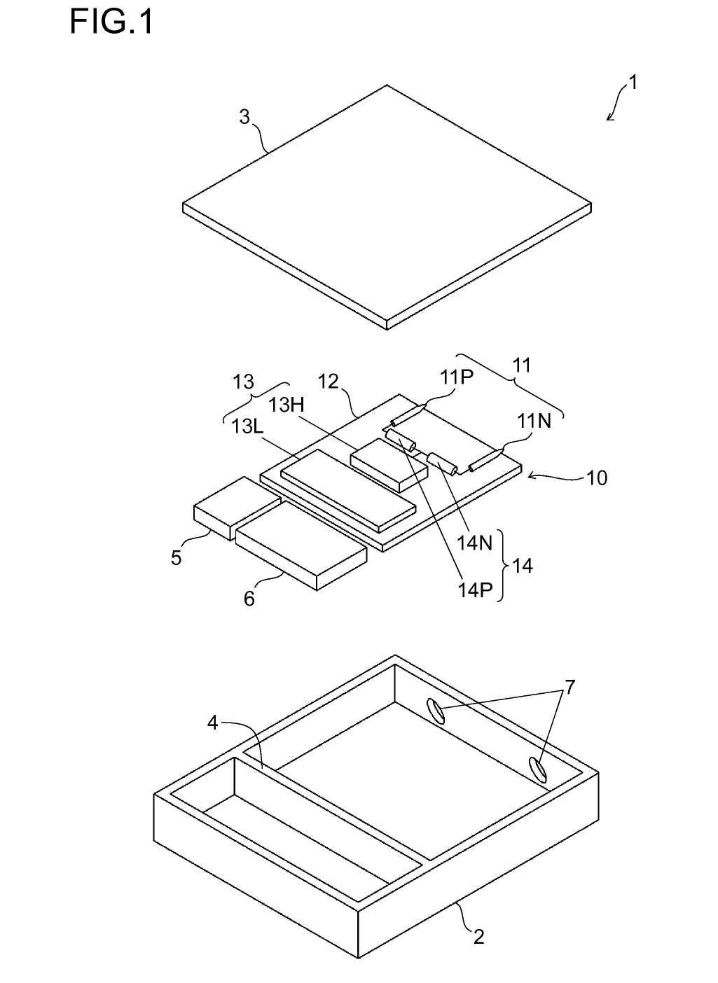

Hereinafter, embodiments of the present invention will be described with reference to the accompanying drawings, which comprise FIGS. 1 to 11.

First, as to an ion generating apparatus according to a first embodiment of the present invention, an outline of its structure will be described with reference to FIG. 1. FIG. 1 is an exploded perspective view of the ion generating apparatus.

The ion generating apparatus 1 has a housing 2 formed like a tray having a rectangular shape as seen in a plan view, and a lid 3 formed like a flat plate having a rectangular shape as seen in a plan view.

The housing 2 is open at the top face, and to cover and close the opening, the lid 3 is fitted at the top face of the housing 2. Inside the housing 2, a partition 4 is provided which divides the space inside into two, a larger and a smaller, compartments. In the larger compartment inside the housing 2, an ion generating element 10 is accommodated; in the smaller compartment, a power/control circuit 5 and a battery 6 are accommodated.

The ion generating element 10 has a base plate 12, on which are mounted an ion discharger 11, for effecting electric discharge to discharge ions, and other electronic components. The ion generating element 10 has, as the ion discharger 11, a pair of ion dischargers that point out of the ion generating apparatus 1 through two circular openings 7 formed in the front face of the housing 2. The ion generating element 10 discharges ions generated by electric discharge at the ion discharger 11 into air passing outside the ion generating apparatus 1 such that the air contains the ions.

The power/control circuit 5 comprises a power supply and a control circuit for operating the ion generating element 10. The power/control circuit 5 comprises a CPU (not shown) and other electronic components for overall control of the ion generating element 10, and comprises a memory for storing programs and data. The CPU in the power/control circuit 5 achieves a sequence of ion discharging operation by controlling the components of the ion generating element 10 based on the programs and data previously stored in the memory.

The battery 6 supplies electric power to the ion generating element 10 and the power/control circuit 5. The ion generating apparatus 1 may instead be so configured as to be supplied with electric power not from a battery 6 but from a commercial alternating-current electric power supply via a power plug and an AC adaptor.

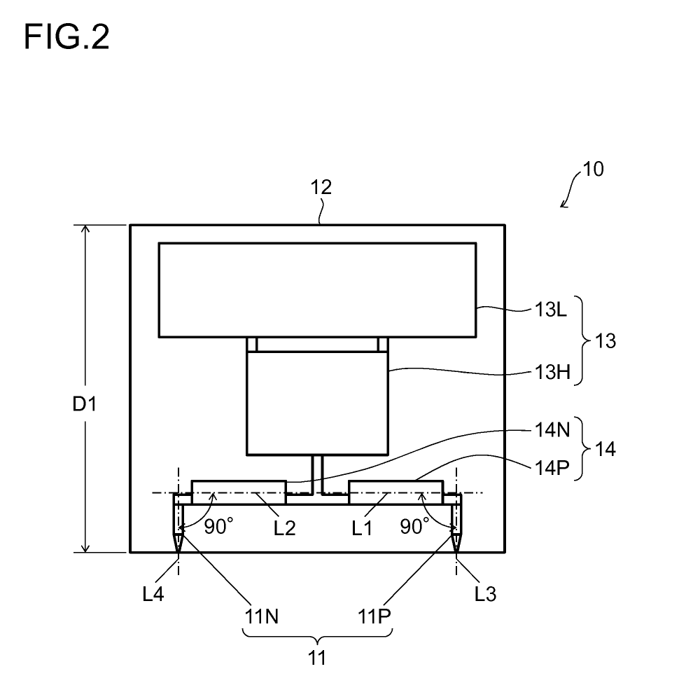

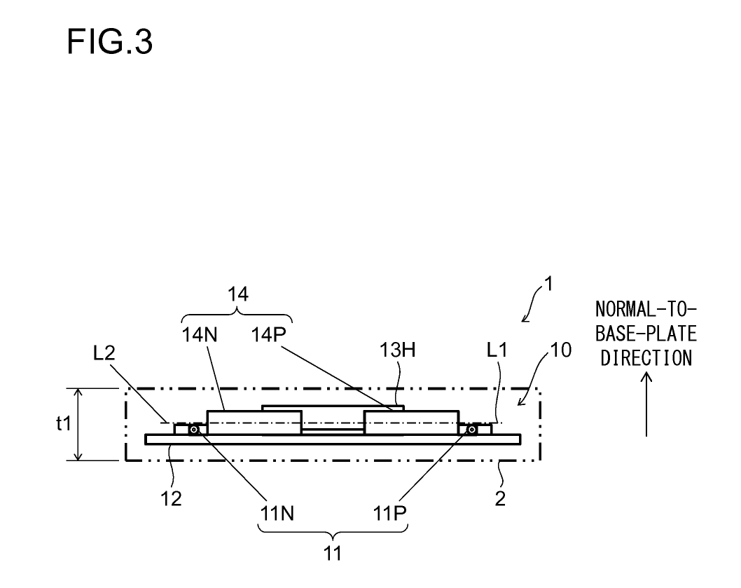

Next, the structure of the ion generating element 10 will be described in detail with reference to, in addition to FIG. 1, FIGS. 2 and 3. FIG. 2 is a top view of the ion generating element 10, and FIG. 3 is a front view of the ion generating element 10.

As shown in FIGS. 2 and 3, the ion generating element 10 further comprises, in addition to the ion discharger 11 and the base plate 12 mentioned above, a voltage generator 13 and a rectifier 14.

The voltage generator 13 generates a voltage to be applied to the ion discharger 11, and includes a low-voltage circuit 13L and a high-voltage circuit 13H.

The low-voltage circuit 13L comprises a circuit that generates a signal for controlling electric discharge by adjusting the electric power obtained from the battery 6 to an adequate output. The low-voltage circuit 13L includes, as principal components for control of electric discharge, for example, a pulse generating circuit, a capacitor, an FET (field-effect transistor), etc. The low-voltage circuit 13L steps up the voltage from the battery 6, for example several volts, to for example about 10 V to 20 V.

The high-voltage circuit 13H generates a high voltage from the signal fed to it from the low-voltage circuit 13L, and, to that end, comprises, for example, a transformer. The high-voltage circuit 13H generates, for example, high positive and negative voltages of 2 kV to 10 kV.

The rectifier 14 is connected between the ion discharger 11 and the voltage generator 13. The rectifier 14 applies either the positive or negative voltage generated by the voltage generator 13 to the ion discharger 11, and, to that end, comprises diodes or the like. The rectifier 14 includes a positive-side rectifier 14P and a negative-side rectifier 14N.

The positive and negative-side rectifiers 14P and 14N each have an elongate shape like a bar, and are arranged on the surface of the base plate 12 such that the axial line L1 of the positive-side rectifier 14P and the axial line L2 of the negative-side rectifier 14N are aligned with each other. The positive-side rectifier 14P is connected to a positive ion discharger 11P, described later, to apply the positive voltage alone to the positive ion discharger 11P. The negative-side rectifier 14N is connected to a negative ion discharger 11N, described later, to apply the negative voltage alone to the negative ion discharger 11N.

Here, the ion discharger 11, the voltage generator 13, and the rectifier 14 are fixed to the base plate 12. This structure requires only one base plate 12, and thus helps reduce the number of base plates used and thereby cut costs.

However, in cases where, due to restrictions associated with component arrangement for instance, the ion discharger 11 needs to be separated from other components, at least the base plate 12 can be fixed to the ion discharger 11. Even in such cases, it is preferable that the high-voltage circuit 13H, the rectifier 14, and the ion discharger 11 be mounted on the base plate 12. The reason is: a high voltage of several kilovolts is present on the path from the high-voltage circuit 13H to the ion discharger 11, and unintended electric discharge to an object nearby may occur, possibly leading to increased power consumption and destruction of the object nearby.

The ion discharger 11 includes a pair of ion dischargers, namely the positive and negative ion dischargers 11P and 11N, which point out of the ion generating apparatus 1 through the two circular openings 7 (see FIG. 1) in the housing 2. The positive and negative ion dischargers 11P and 11N are formed of, for example, a metal with high heat resistance and high corrosion resistance, such as Inconel (a registered trademark), and each have a straight shape with a pointed end, like a needle. The positive and negative ion dischargers 11P and 11N are, at their respective pointed ends, exposed in the air, and are, at the other ends, that is, the base ends, connected to the positive and negative-side rectifiers 14P and 14N respectively.

A voltage having an alternating-current waveform or an impulse waveform is applied to the positive and negative ion dischargers 11P and 11N. A positive voltage is applied to the positive ion discharger 11P, and this causes hydrogen ions resulting from corona discharge to bond with moisture in the air to produce positive ions (cations) mainly comprising H⁺(H₂O)ₘ. A negative voltage is applied to the negative ion discharger 11N, and this causes oxygen ions resulting from corona discharge to bond with moisture in the air to produce negative ions (anions) mainly comprising O₂⁻(H₂O)ₙ. Here, m and n are each a natural number. The ions H⁺(H₂O)ₘ and O₂⁻(H₂O)ₙ flock together on the surface of microbes and odor particles in the air and envelop them.

As expressed by formulae (1) to (3) below, the ions collide and flock together to produce active species such as [•OH] (hydroxy radical) and H₂O₂ (hydrogen peroxide) on the surface of microorganism etc., and thereby destroy microbes and odor particles. Here, m′ and n′ are each a natural number. By generating positive and negative ions and discharging them out of the ion generating apparatus 1 in this way, it is possible to eliminate microbes and odors outside the ion generating apparatus 1.

H⁺(H₂O)ₘ+O₂⁻(H₂O)ₙ→•OH+½O₂ +(m+n)H₂O (1)

H⁺(H₂O)ₘ+H⁺(H₂O)_{m′}+O₂⁻(H₂O)ₙ+O₂⁻(H₂O)_{n′}→2•OH+O₂+(m+m′+n+n′)H₂O (2)

H⁺(H₂O)ₘ+H⁺(H₂O)_{m′}+O₂⁻(H₂O)ₙ+O₂⁻(H₂O)_{n′}→H₂O₂+O₂+(m+m′+n+n′)H₂O (3)

Although in this embodiment the ion generating element 10 generates both positive and negative ions, it may generate negative ions alone.

In the present invention, it is assumed that the ions contain electrically charged water microparticles. That is, the ion generating apparatus 1 comprises an electrostatically atomizing apparatus, which generates electrically charged water microparticles containing radical components. Specifically, a discharge electrode provided in the electrostatically atomizing apparatus is cooled with a Peltier-effect device to deposit condensed water (dew) on the surface of the discharge electrode. Then, applying a high negative voltage to the discharge electrode causes electrically charged water microparticles to be generated from the condensed water. Along with the electrically charged water microparticles, negative ions are discharged from the discharge electrode into the air.

The positive and negative ion dischargers 11P and 11N, each having a straight shape with a pointed end, like a needle, are arranged to be perpendicular to the normal line to the base plate 12, that is, parallel to the surface of the base plate 12. The axial line L3 of the positive ion discharger 11P and the axial line L4 of the negative ion discharger 11N are parallel to each other.

The rectifier 14 is arranged at the side of the ion discharger 11 opposite from its pointed-end side (that is, at the base-end side of the ion discharger 11) such that the longitudinal direction of the rectifier 14 crosses, and in particular is substantially perpendicular to, the axial-line direction of the ion discharger 11. That is, the axial line L1 of the positive-side rectifier 14P is perpendicular to the axial line L3 of the positive ion discharger 11P, and the axial line L2 of the negative-side rectifier 14N is perpendicular to the axial line L4 of the negative ion discharger 11N.

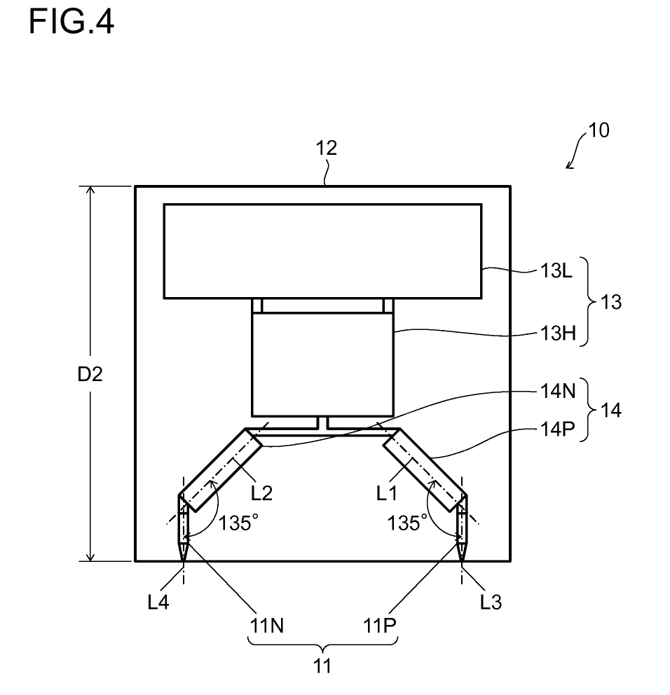

Next, an ion generating element according to a second embodiment of the present invention will be described with reference to FIG. 4. FIG. 4 is a top view of the ion generating element. The structure according to this embodiment is basically the same as that according to the first embodiment described above with reference to FIGS. 1 to 3; accordingly such components as find their counterparts in the first embodiment are identified by common reference signs, and no overlapping description will be repeated.

In the ion generating element 10 according to the second embodiment, as shown in FIG. 4, the axial line L1 of the positive-side rectifier 14P is at an angle of 135 degrees to the axial line L3 of the positive ion discharger 11P, and the axial line L2 of the negative-side rectifier 14N is at an angle of 135 degrees to the axial line L4 of the negative ion discharger 11N.

Next, a description will be given of evaluation of the ion generating elements 10 according to the first and second embodiments described above, in terms of the number of ions they discharge and their compactness, with reference to, in addition to FIGS. 2 and 4, FIGS. 5 and 6.

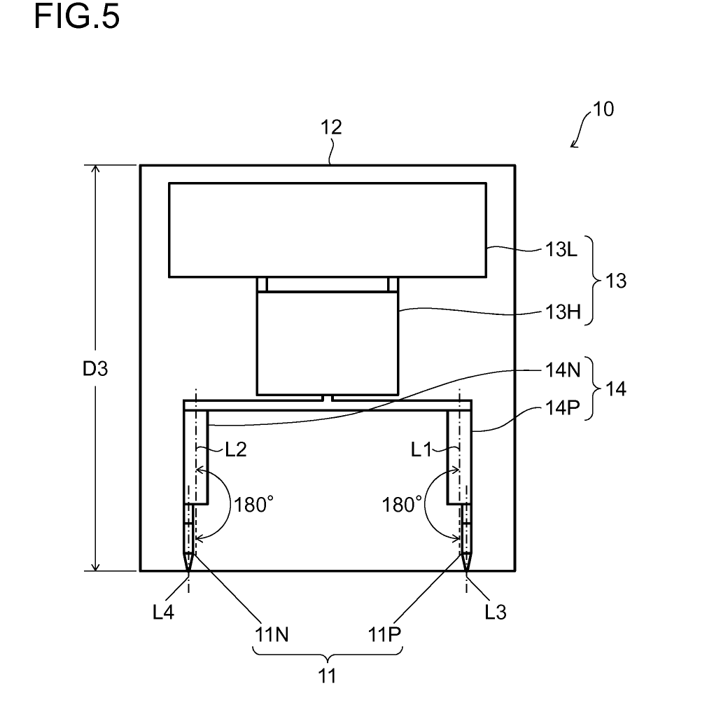

FIG. 5 is a top view of an ion generating element 10 of a comparative example for comparison with the embodiments according to the present invention. In the ion generating element 10 of the comparative example, as shown in FIG. 5, the axial line L1 of the positive-side rectifier 14P is substantially parallel to (at an angle of 180 degrees to) the axial line L3 of the positive ion discharger 11P, and the axial line L2 of the negative-side rectifier 14N is substantially parallel to (at an angle of 180 degrees to) the axial line L4 of the negative ion discharger 11N.

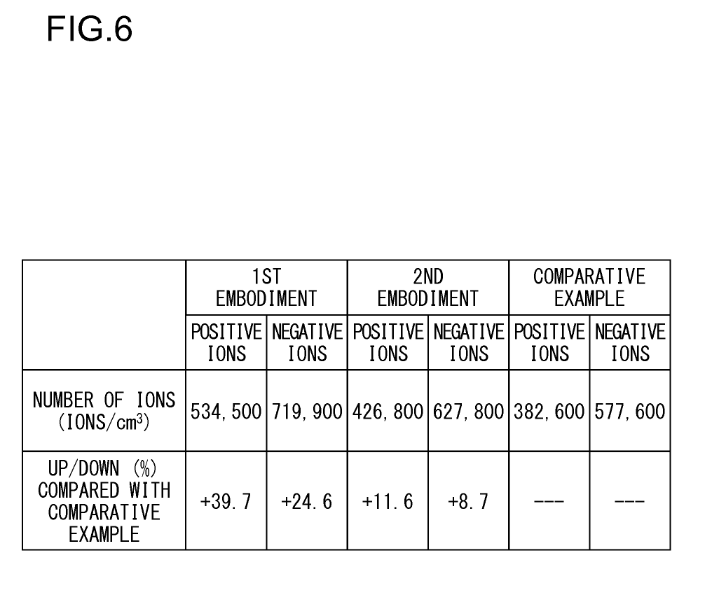

FIG. 6 is a table showing the results of comparison of the numbers of ions discharged in the embodiments of the present invention and in the comparative example. In all cases, the ion generating element 10 was operated with a voltage of about 5 kV applied to the pointed end of the ion discharger 11, the number of ions being counted at a distance of 10 cm from the pointed end of the ion discharger 11 along its corresponding axial line.

The results reveal the following. The ion generating element 10 according to the first embodiment discharged 534,500 ions/cm³ of positive ions and 719,900 ions/cm³ of negative ions. The ion generating element 10 of the second embodiment discharged 426,800 ions/cm³ of positive ions and 627,800 ions/cm³ of negative ions. The ion generating element 10 of the comparative example discharged 382,600 ions/cm³ of positive ions and 577,600 ions/cm³ of negative ions. That is, the second embodiment yielded about 12% more positive ions and about 9% more negative ions than the comparative example. The first embodiment yielded about 40% more positive ions and about 25% more negative ions.

Comparing the size of the ion generating elements 10 according to the first and second embodiments with that of the ion generating element 10 of the comparative example on the basis of FIGS. 2, 4, and 5 reveals the following. The depth D2 in the second embodiment is smaller than the depth D3 in the comparative example, and the depth D1 in the first embodiment is still smaller than the depth D2 in the second embodiment.

A conclusion is thus reached that, by making the longitudinal direction of the rectifier 14 cross, and in particular perpendicular to, the axial-line direction of the ion discharger 11, it is possible to discharge more ions and to make the ion generating element 10 more compact.

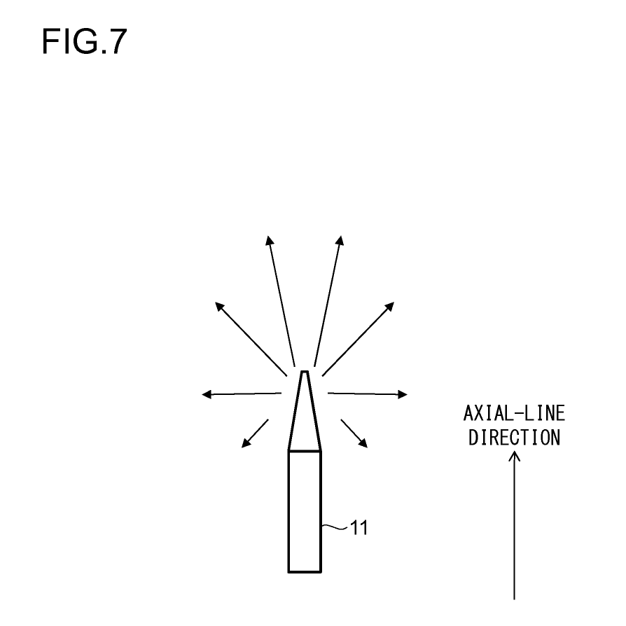

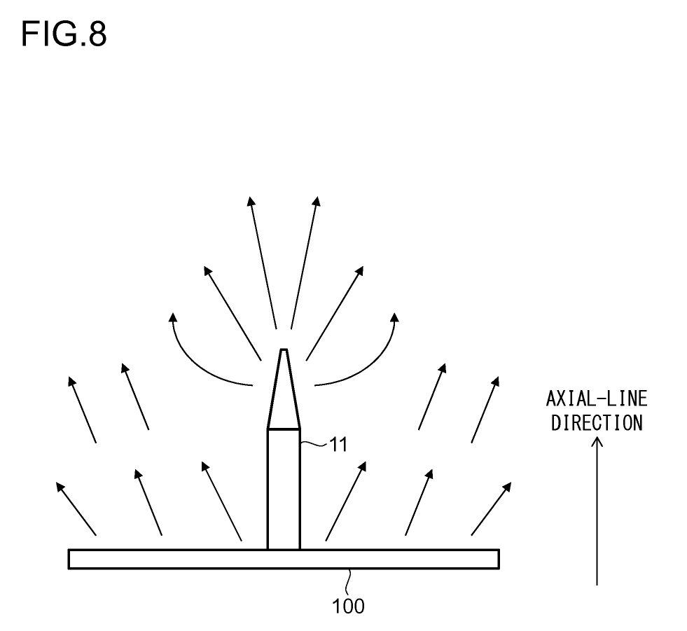

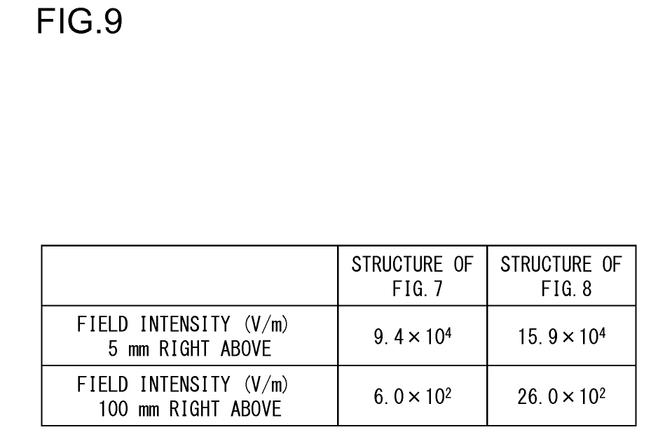

Next, a description will be given of the effect resulting from the ion generating element 10 according to the first embodiment discharging more ions than the ion generating element 10 of the comparative example, with reference to FIGS. 7 to 9. FIG. 7 is a diagram illustrating the directions in which ions are discharged from an ion discharger alone, and FIG. 8 is a diagram illustrating the directions in which ions are discharged from an ion discharger connected to an electrode. FIG. 9 is a table showing the results of comparison of field intensity between the ion dischargers structured as shown in FIGS. 7 and 8. In FIGS. 7 and 8, arrows around the ion discharger 11 indicate approximate directions of ion discharge.

With an ion discharger 11 alone, as shown in FIG. 7, ions are considered to be discharged so as to radially spread from the pointed end of the ion discharger 11. That is, while ions are discharged in directions away from the pointed end largely along the axial-line direction of the ion discharger 11 (upward in FIG. 7), some ions are discharged sideways from the pointed end and in directions toward the base end (downward in FIG. 7).

By contrast, in a case where the ion discharger 11 is connected, at its end opposite from its pointed end (that is, at its base end, the lower end in FIG. 8), to another component such as an electrode 100, as shown in FIG. 8, most ions are considered to be discharged in directions away from the pointed end along the axial-line direction of the ion discharger 11 (upward in FIG. 8).

Such behavior of ions is verified by the results in FIG. 9. FIG. 9 shows the results of simulation of the field intensity right over the ion discharger 11, that is, at a predetermined distance away from it along the axial-line direction in the ion dischargers 11 structured as shown in FIGS. 7 and 8. The results reveal that, in the structure shown in FIG. 8, the field intensity at a distance of 5 mm, and at a distance of 100 mm, right over the ion discharger 11 is higher than in the structure shown in FIG. 7. It is understood that, under the influence of the electric field produced around the electrode 100, the electric field produced around ion discharger 11 in directions away from its pointed end tends to be more intense.

Accordingly, in the ion generating element 10 provided in the ion generating apparatus 1, as described above, the rectifier 14 is formed to have an elongate shape, and is arranged at the side of the ion discharger 11 opposite from its pointed end such that the longitudinal direction of the rectifier 14 crosses the axial-line direction of the ion discharger 11 shaped like a needle. With this structure, under the influence of the electric field produced around the rectifier 14, the electric field produced around the ion discharger 11 in directions away from its pointed end tends to be more intense. Thus, it is possible, with no provision of an extra member at the pointed-end side of the ion discharger 11, to make it easier for ions to be discharged in directions away from the ion discharger 11.

In particular, in the ion generating element 10 according to the first embodiment, the rectifier 14 is arranged such that its longitudinal direction is substantially perpendicular to the axial-line direction of the ion discharger 11. Thus, under the electric field produced around the rectifier 14, the electric field produced around the ion discharger 11 in directions away from the pointed end of the ion discharger 11 tends to be still more intense. It is thus possible to make it still easier for ions to be discharged in directions away from the ion discharger 11.

Moreover, in the ion generating element 10, the axial line of the ion discharger 11 is perpendicular to the normal line to the base plate 12, and this further reduces the size of the ion generating element 10 in the normal-line direction to the base plate 12. This helps make the ion generating element 10 more compact.

Moreover, in the ion generating element 10, the ion discharger 11 includes the positive ion discharger 11P for generating positive ions and the negative ion discharger 11N for generating negative ions, and the rectifier 14 includes the positive-side rectifier 14P connected to the positive ion discharger 11P to apply a positive voltage alone to the positive ion discharger 11P and the negative-side rectifier 14N connected to the negative ion discharger 11N to apply a negative voltage alone to the negative ion discharger 11N. With this structure, the positive ion discharger 11P is influenced by the electric field produced around the positive-side rectifier 14P, and the negative ion discharger 11N is influenced by the electric field produced around the negative-side rectifier 14N, so that the electric field produced around the ion discharger 11 in directions away from its pointed end tends to be more intense. Thus, with respect to both the positive and negative ion dischargers 11P and 11N, it is possible to make it easier for ions to be discharged in directions away from the ion discharger 11.

Moreover, in the ion generating element 10, the axial line of the positive ion discharger 11P and the axial line of the negative ion discharger 11N are substantially parallel to each other, and the axial line of the positive-side rectifier 14P and the axial line of the negative-side rectifier 14N are substantially aligned with each other. Thus, the positive and negative ion dischargers 11P and 11N and the positive and negative-side rectifiers 14P and 14N can be arranged in a comparatively small space, and this helps make the ion generating element 10 more compact.

Furthermore, the ion generating apparatus 1 is provided with the ion generating element 10 structured as described above. Thus, it is possible, with no provision of a blowing means such as a blower fan, to make it easier for ions to be discharged in directions away from the ion generating element 10.

With the above-described structures according to the embodiments of the present invention, it is possible, with no provision of an extra member at the pointed-end side of the ion discharger 11, to make it easier for ions to be discharged in directions away from the ion discharger 11. Thus, it is possible to provide an ion generating element 10 that is compact, that has a simple structure, and that can diffuse ions satisfactorily with no provision of a blowing means such as a blower fan. It is also possible to provide an ion generating apparatus 1 provided with such an ion generating element 10.

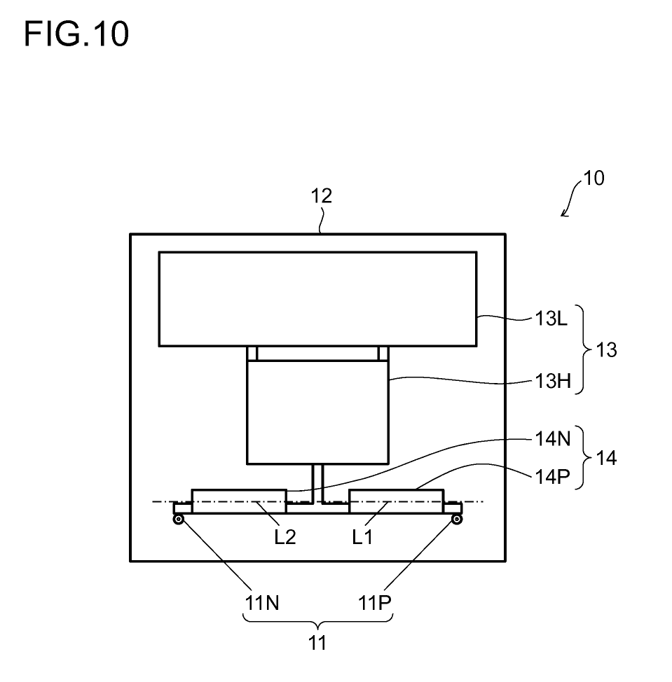

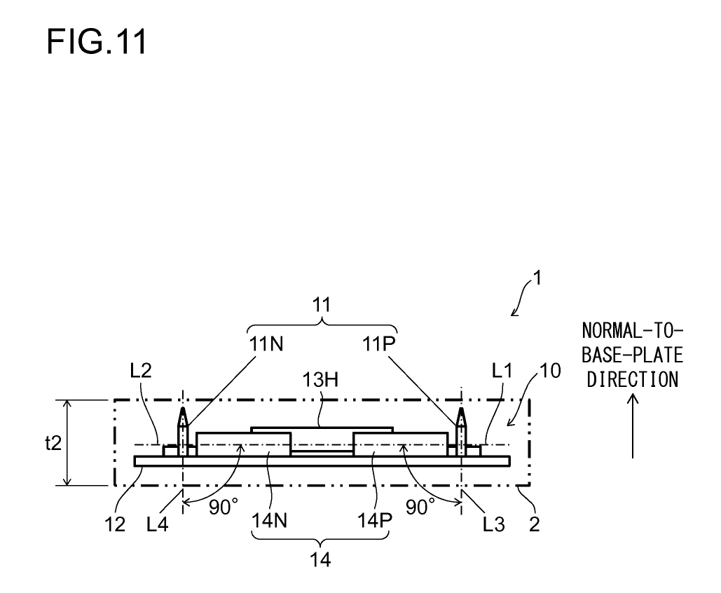

Next, an ion generating apparatus according to a third embodiment of the present invention will be described with reference to FIGS. 10 and 11. FIG. 10 is a top view of an ion generating element in the ion generating apparatus, and FIG. 11 is a front view of the ion generating element. The structure in this embodiment is basically the same as that in the first embodiment described above with reference to FIGS. 1 to 3; accordingly such components as find their counterparts in the first embodiment are identified by common reference signs, and no overlapping description will be repeated.

In the ion generating element 10 provided in the ion generating apparatus 1 according to the third embodiment, as shown in FIGS. 10 and 11, the positive and negative ion dischargers 11P and 11N are provided so as to be parallel to the normal line to the base plate 12, that is, perpendicular to the surface of the base plate 12. Moreover, the axial line L1 of the positive-side rectifier 14P is perpendicular to the axial line L3 of the positive ion discharger 11P, and the axial line L2 of the negative-side rectifier 14N is perpendicular to the axial line L4 of the negative ion discharger 11N.

With this structure, it is possible not only to make the ion generating element 10 compact, but also to diversify the directions in which ions are discharged. Specifically, in apparatuses that incorporate the ion generating element 10, appropriate ion discharge directions can be selected to suit the arrangement of components around the ion generating element 10. When attention is paid to the thickness of the ion generating apparatus 1, the thickness t1 of the ion generating apparatus 1 according to the first embodiment shown in FIG. 3 is smaller than the thickness t3 of the ion generating apparatus 1 according to the third embodiment shown in FIG. 11. Thus, it can be said that the first embodiment is more effective in terms of making the apparatus slim.

It should be understood that the embodiments by way of which the present invention has been described are not meant to limit the scope of the invention but allow for many modifications without departing from the spirit of the invention.

### INDUSTRIAL APPLICABILITY

The present invention finds application in ion generating elements that generate ions in the air by electric discharge.

### LIST OF REFERENCE SIGNS

1 ion generating apparatus
2 housing
3 lid
10 ion generating element
11 ion discharger
11P positive ion discharger
11N negative ion discharger
12 base plate
13 voltage generator
13H high-voltage circuit
13L low-voltage circuit
14 rectifier
14P positive-side rectifier
14N negative-side rectifier

1. An ion generating element comprising:
an ion discharger having a needle-like shape for generating ions in air by electric discharge;
a voltage generator for generating a voltage to be applied to the ion discharger; and
a rectifier connected between the ion discharger and the voltage generator for applying either a positive or a negative voltage generated by the voltage generator to the ion discharger,
wherein
the rectifier has an elongate shape, and
the rectifier is arranged at a side of the ion discharger opposite from a pointed-end side thereof such that a longitudinal direction of the rectifier crosses an axial-line direction of the ion discharger.

2. The ion generating element according to claim 1,
wherein the rectifier is arranged such that the longitudinal direction thereof is substantially perpendicular to the axial-line direction of the ion discharger.

3. The ion generating element according to claim 1, further comprising a base plate on which the ion discharger is mounted,
wherein an axial line of the ion discharger is perpendicular to a normal line to the base plate.

4. The ion generating element according to claim 1, further comprising a base plate on which the ion discharger is mounted,
wherein an axial line of the ion discharger is parallel to a normal line to the base plate.

5. The ion generating element according to claim 1,
wherein
the ion discharger includes a positive ion discharger for generating positive ions and a negative ion discharger for generating negative ions, and
the rectifier includes a positive-side rectifier connected to the positive ion discharger for applying a positive voltage alone to the positive ion discharger and a negative-side rectifier connected to the negative ion discharger for applying a negative voltage alone to the negative ion discharger.

6. The ion generating element according to claim 5,
wherein
an axial line of the positive ion discharger and an axial line of the negative ion discharger are substantially parallel to each other, and
an axial line of the positive-side rectifier and an axial line of the negative-side rectifier are substantially parallel to each other or are substantially aligned with each other.

7. An ion generating apparatus comprising the ion generating element according to claim 1.
